(19) United States
(12) Patent Application Publication
(10) Pub. No.: US 2011/0301987 A1
(43) Pub. Date: Dec. 8, 2011

(54) REAL ESTATE DRIVE BY TRAFFIC MONITORING SYSTEM

(76) Inventor: Steven Paul Wiese, Farmington, MI (US)

(21) Appl. No.: 13/152,024

(22) Filed: Jun. 2, 2011

Related U.S. Application Data
(60) Provisional application No. 61/396,712, filed on Jun. 2, 2010.

(51) Int. Cl. G06Q 10/00; G06Q 50/00

(52) U.S. Cl. 705/7.11

(57) ABSTRACT

A method and system for tracking real estate drive by traffic monitors locations of the mobile devices of interested parties relative to real property for sale. Visits to the real properties are counted, monitored and tracked to determine the amount of traffic of interested parties that each real property is receiving. Durations of visits are also monitored. Identifying profile information of the interested parties can be provide with the consent of the interested parties, optionally in exchange for increased access to additional information regarding the real properties.

This application claims priority to U.S. Provisional Application Ser. No. 61/396,712, filed Jun. 2, 2010.

### BACKGROUND

The present invention relates generally to a real estate tracking system. Currently homes listed for sale only track interest by typical web site or tracking functions. This can be deceiving because information is often downloaded or printed, so the tracking may not give a true indication of people's interest in such listings.

### SUMMARY

The present invention provides a method and computer system for tracking and monitoring visits to real property that is for sale. Tracking the actual drive-by of a potential buyer or interested party provides an indicator of interest in that real property. This can be done by using current technology such as but not limited to cell phone signals, gps, etc. These signals indicates the location of the user that with the location of the real estate for sale by geocoding or other means will indicate the potentially interested parties amount, frequency, duration and proximity of visits to the location of the real estate for sale. This will be reported back to the interested party. Other identifying signals could be used such as vehicle navigation, radio signals, On Star, Satellite and so on. Any signal that can locate and be associated with the interested party with enough accuracy could be used.

### BRIEF DESCRIPTION OF THE DRAWINGS

The above, as well as other advantages of the present invention, will become readily apparent to those skilled in the art from the following detailed description of a preferred embodiment when considered in light of the accompanying drawings in which:

FIG. 1 is a schematic of a tracking system of the present invention;

FIG. 2 shows a map of the tracking system of FIG. 1 in operation.

FIG. 3 shows one possible screen for use by a real estate agent.

FIG. 4 shows a second possible screen for use by a real estate agent.

### DETAILED DESCRIPTION OF THE PREFERRED EMBODIMENT

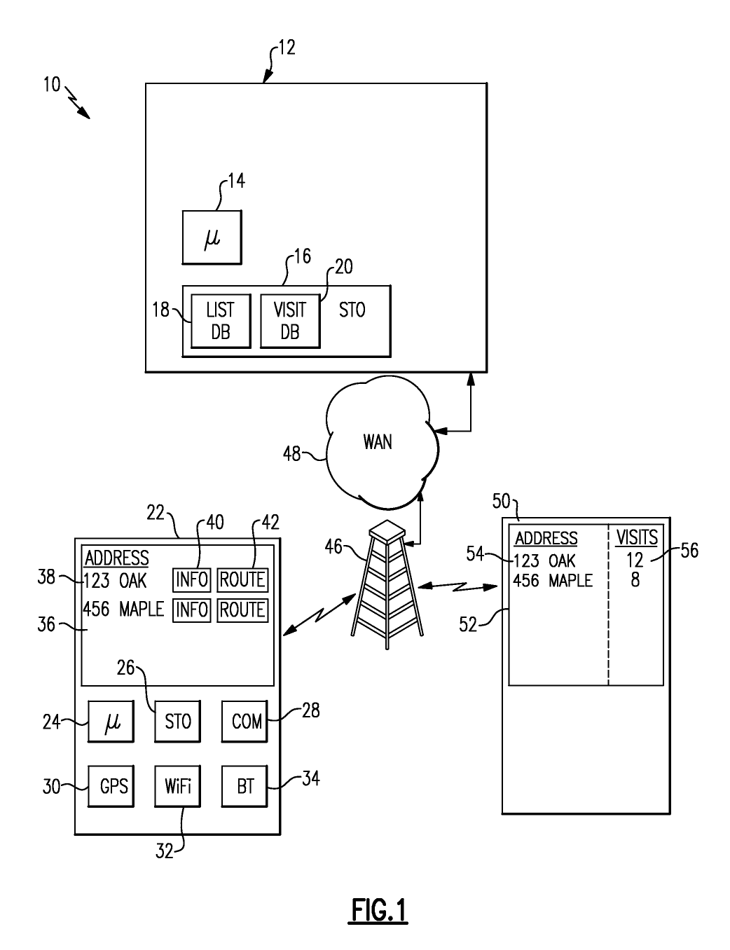

The present invention provides a system 10, as shown in FIG. 1, for tracking and monitoring potential interested visitors of real property for sale. The system 10 includes a server 12 having a processor 14 and storage 16 (memory, hard drives, etc) storing a listings database 18 of real properties for sale and a visitor database 20 of the potential interested visitors.

The system 10 further includes a user mobile device 22, such as a cell phone, such as a smart phone or optionally even a PDA, iPod, iPad, or similar mobile device. The mobile device includes a processor 24, storage 26 and one or more of the following: a communications module 28 (cell phone communication, 3G, 4G, voice and/or data, etc), a gps receiver 30, wi-fi module 32 and Bluetooth module 34 (or similar short-range wireless communication). The mobile device 24 communicates with the server 12 via a wide area network 48 (such as the internet), such as via cell towers 46 or via wi-fi or other known methods. The mobile device 22 includes a display 36 such as a touch-screen for displaying information from and communicating information to the server 12. The mobile device 22 may access the server 12 via a web browser or via a dedicated application stored on the mobile device 22.

The user can access the listings database 18 from the user mobile device 22. As shown in FIG. 1, the display 36 displays a list of real properties for sale in the listings database 18. The screen may offer additional information with an “info” button 40, where the user can obtain additional information about the particular listing. The screen may offer a “route” button 42, which would provide a map or navigation to the location of the real property for sale.

In one optional implementation, the server 12 does not provide additional information (or, optionally, a route to the listing) unless the user creates a profile on the visitor database 20 and consents to being tracked and monitored in the manner described herein. In the user's profile, the user may indicate that they are a potential purchaser, along with what types of real property they are seeking, what price range, location, etc. The user may also indicate in the profile that they are not a potential purchaser, but a real estate agent (e.g. a buyer's agent).

A real estate agent (e.g. seller's agent) may have a different application (or just different access privileges) on an agent mobile device 50, which is otherwise identical to the user mobile device 22. On the display 52 on the agent mobile device 50, the agent can see a list 54 of real property listed by that agent, including a number of visits 56 for each real property listing.

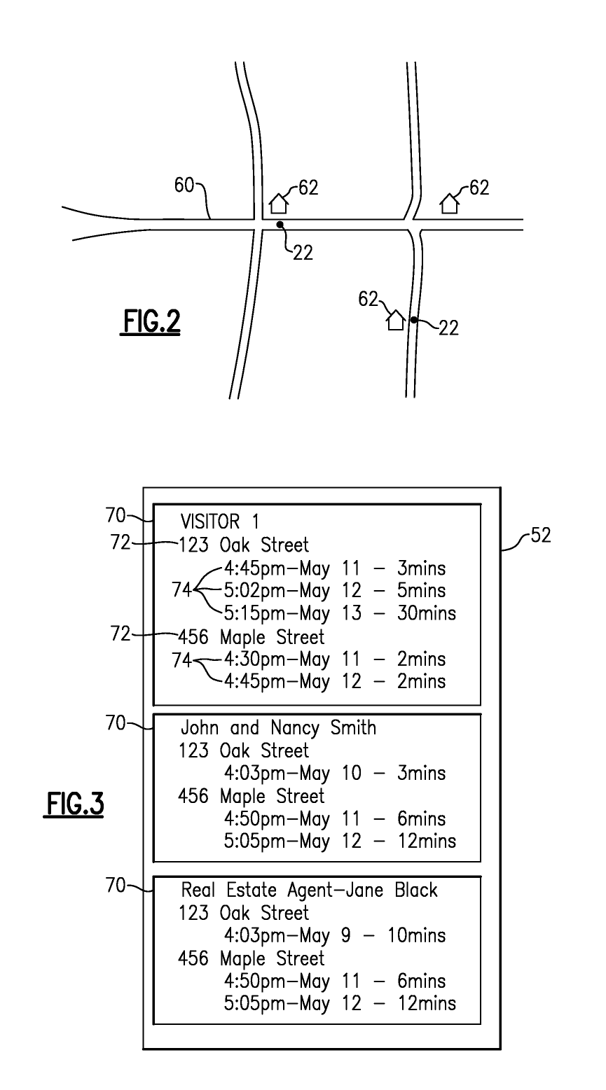

Referring to FIGS. 1 and 2, the system 10 tracks the location of a plurality of mobile devices 22. The mobile devices 22 may report their own locations (as determined by gps receiver 30, for example) to the server 12 periodically, or the locations of the mobile devices 22 may be determined through cell tower triangulation. If the mobile devices 22 are determined to be within a minimum distance of one of the real properties 62 for sale, that visit is recorded by server 12. The date, time and duration of each visit is associated with that real property and recorded in the listings database 18 by the server 12. The server 12 may associate a specific user profile with the visit, or alternatively, the visit can be anonymized such that the specific user cannot be identified with that visit, but the total numbers of visitors is recorded (along with date, time and duration). Even if anonymous, it would still be preferable to record whether the user was a potential interested purchaser or a real estate agent.

Alternatively, the tracking can be performed on the mobile device 22 itself. If the mobile device 22 downloads the locations of the listings from server 12, then the mobile device 22 can monitor its location relative to those locations. When the minimum distance is reached, a visit is recorded on the mobile device 22, which then collects date, time and duration of the visit. Periodically, or after the minimum distance is later exceeded, the mobile device 22 reports the visit to the server 12 to be combined with visits from other mobile devices 22 for other users.

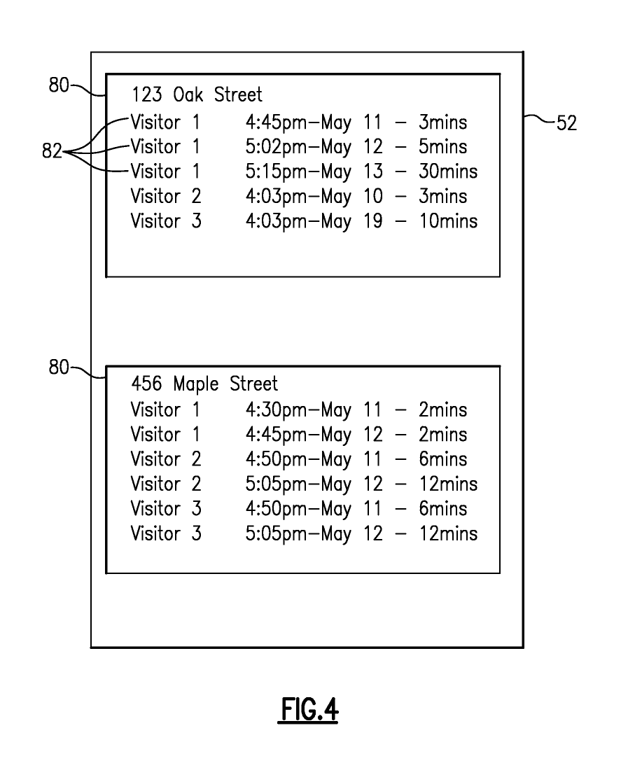

The accumulated visits can be reported to the listing agent as shown in the display 52 in FIG. 1. Additionally, the visits can be reported to the listing agent as shown on the display 52 in FIG. 3. In FIG. 3, the visits 74 are ordered by visitor 70, and then by property 72. As shown, the visitors 70 may be anonymous (“Visitor 1”), identifying (“John and Nancy Smith”) and/or may indicate whether the visitor 70 is another agent (“Real Estate Agent—Jane Black”).

The agent can also choose to have the visits reported as shown in FIG. 4, where they are ordered by property 80, then by visit 82. In FIG. 4, the visitors are shown anonymously, but they could alternatively be identified as in FIG. 3.

In this manner, the listing agent can obtain useful information regarding the multiple properties that the agent has listed. The agent can determine which properties seem to have the most interest and which properties may need additional advertising or publicity. The agent may be able to identify potential purchasers (if such info is provided) to encourage them to purchase one of the properties. If the visitor is another agent, then this system 10 simplifies the process of identifying which agent brought a potential purchaser to a property, especially if both the agent and the potential purchaser have mobile devices which are being tracked, such that it can be shown that they were at the property at the same time.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A method of monitoring traffic at a location of a real property for sale:
a) identifying a mobile device of a potential interested visitor of a real property;
b) determining a location of the mobile device relative to the real property;
c) monitoring visits of the potential interested visitor to the real property via step b); and
d) providing a report of the visits monitored in step c).

2. The method of claim 1 wherein said step a) further includes the step of receiving a consent to be tracked by the potential interested visitor.

3. The method of claim 2 wherein said step a) wherein the potential interested visitor is granted access to information regarding the real property in exchange for the consent to be tracked.

4. The method of claim 1 wherein said step d) further includes the step of providing anonymous data of the visits.

5. The method of claim 1 wherein the real property is one of a plurality of real properties, and wherein said step b) includes determining the location of the mobile device relative to each of the plurality of real properties.

6. The method of claim 1 wherein said step c) includes the step of recording occurrences of a visit based upon the location of the mobile device being within a minimum distance of the location of the real property.

7. The method of claim 6 wherein in said step c) only occurrences of visits are recorded and no other locations of the mobile device are recorded.

8. The method of claim 1 wherein step c) includes monitoring durations of each of the visits.

9. The method of claim 1 further including the steps of receiving profile information regarding the potential interested visitor of the real property and associating the profile information with the mobile device.

10. The method of claim 9 wherein the profile information includes an indicator that the potential interested visitor is a potential purchaser.

11. The method of claim 9 wherein the profile information includes an indicator that the potential interested visitor is a real estate agent.

12. The method of claim 1 wherein step d) further includes the step of providing the report on an agent mobile device.

13. The method of claim 1 wherein said step c) is performed by a server including a database of listings of real properties for sale, including the real property.

14. The method of claim 13 wherein step b) is performed by comparing a gps location of the mobile device to the location of the real property.

15. A mobile device comprising:
a processor;
a gps receiver;
a communications module for receiving data wirelessly;
storage; and
wherein the processor is programmed to retrieve a list of real property for sale and locations of the real property for sale via the communications module and store it in the storage, the processor programmed to monitor a current location of the mobile device and record a visit whenever the current location is near one of the locations of the real property for sale.

16. A system including the mobile device of claim 15, the system further including a server having a database from which the mobile device retrieves the real property for sale.

17. A system for tracking visits to real property for sale including:
a server storing a database of listings of real property for sale including locations of the real property for sale; and
the server programmed to record visits of each of the listings of real property based upon a determination that a mobile device of a potential interested person is near.
